(19) United States
(12) Patent Application Publication
(10) Pub. No.: US 2010/0003653 A1
(43) Pub. Date: Jan. 7, 2010

(54) SYSTEM AND METHOD FOR AUTOMATED BEHAVIORAL COACHING

(76) Inventor: Wendell Brown, Henderson, NV (US)

Correspondence Address: Park, Vaughan & Fleming LLP, 2820 Fifth Street, Davis, CA, 95618, US

(21) Appl. No.: 12/205,859

(22) Filed: Sep. 6, 2008

Related U.S. Application Data
(60) Provisional application No. 61/078,370, filed on Jul. 4, 2008.

(51) Int. Cl. G09B 19/00

(52) U.S. Cl. 434/236

(57) ABSTRACT

A system and method for automated coaching to help a person constrain their consumption or other behavior. The constraint may comprise food in general (e.g., calories), may be a specific food component (e.g., sodium, sugar, caffeine), or may be some other substance (e.g., alcohol, cigarettes). The system tracks the user's consumption of the constrained item(s) and offers the person one or more automated coaches to help them make consumption decisions. To help constrain a user's caloric intake, an automated coach offers the user one or more suggestions at the time of a meal event (e.g., lunch, snack, dinner). Each suggestion comprises a number of calories that the user can consume without exceeding a target maximum for the day or other period of time.

### RELATED APPLICATION

This application claims priority to U.S. Provisional Application No. 61/078,370, filed Jul. 4, 2008, which is hereby incorporated by reference.

### BACKGROUND

This invention relates to the fields of computer systems. More particularly, a system and methods are provided for automated coaching to assist a person in meeting behavioral goals within constraints associated with caloric intake, consumption of dietary substances (e.g., sodium, water), use of addictive substances (e.g., cigarettes, alcohol, drugs), etc.

Many studies have shown that the numbers and percentages of people who are overweight or even obese continue to grow. Although a myriad of diets and dietary programs exist to help people control their eating and try to lose weight, the fact that new diets and programs are continually developed and pitched to consumers indicate that most provide little, if any, relief.

One reason so many diets and weight-loss programs fail their participants, or why the participants fail the diets and programs, is the inadequate level of feedback or coaching that participants receive. If a participant only meets with a counselor or has their performance reviewed once a week, once a month or some other infrequent basis, the participant is left to his or her own devices in between discussions, may not be able to easily monitor his or her progress, and thus finds it easier to stray or cheat. Without regular oversight, reporting or encouragement, participants may become discouraged and lose their focus.

Another reason a diet or weight-loss program may fail is because it is too boring or requires an extreme change in behavior by the participant. For example, if the participant is told exactly what to eat, with no options, he or she may naturally feel confined or limited. Similarly, a participant given a list of exercises to perform on a regular basis, with no alteration and with no feedback will also likely grow bored with the plan.

Yet another reason someone trying to lose weight may be unsuccessful may be his or her busy schedule. Someone who is constantly on the move, working, going to school, studying, engaged in after-work or after-school activities, raising a family, and so on, has little time to research diets, nutrition and exercise, let alone constantly monitor his or her progress. And, because few restaurants and food vendors provide easy access to nutritional information for their products, he or she cannot readily determine whether or what type of food he or she can or should consume.

Instead of, or in addition to, losing weight, some people need to restrain other types of behavior or consumption. For example, even someone in good condition may need to or want to restrict their consumption of food components or ingredients such as sodium, saturated fat, caffeine, cholesterol, etc. Or, to help control a bad habit someone may want to restrict their consumption of alcohol, cigarettes, drugs or some other substance.

### SUMMARY

In one embodiment of the invention, a system and methods are provided for coaching a person to constrain their consumption of food in general, particular food ingredients or components (e.g., sodium, cholesterol), or other substances (e.g., alcohol, cigarettes, drugs). The person's consumption of other things (e.g., vitamins, minerals, carbohydrates) may also be monitored to help them meet target consumption levels or avoid exceeding limits.

In one implementation, a user has a target maximum number of calories that may be consumed per day or other period of time. The target number of calories may be budgeted across any number of meal events during the day (e.g., breakfast, lunch, dinner, snacks), and the user's actual consumption is tracked while providing feedback to help him or her remain within the targeted limit.

Automated coaches are configured to make suggestions to the user for a meal event. A coach is advised of a maximum number of calories allotted to the event and/or a number of calories the user may consume the remainder of the day. The coach assembles any number of meal options and identifies the caloric value and/or other characteristics of each. Meal options may also be accompanied by controls for ordering an option, reporting the automated coaching system what the user has consumed, directions to a vendor of an option, etc.

The system may communicate with users via mobile telephones, any type of computing device, personal digital assistants, etc., using wired and/or wireless media and protocols. The system may comprise any number of automated coaches, and/or may link to external (e.g., third party) coaches. The system may also link to a user's health care provider, other health-related websites, food vendors (e.g., restaurants), and so on.

In another embodiment of the invention, the system operates in a single-use mode to respond to an immediate request to identify one or more meals based on a specified set of parameters, possibly without any previous knowledge of the requester and without tracking the requester's consumption. In particular, the requester submits her parameters, such as a maximum of 400 calories and low sodium, and the system identifies one or more suitable meal options based on those parameters and the requester's location. Illustratively, the requester's location may be included with the request, or may be received via a GPS-equipped device associated with the requester.

### DESCRIPTION OF THE FIGURES

FIG. 1 is a block diagram of an automated coaching system according to an embodiment of the present invention.

FIG. 2 is a flowchart illustrating one method of coaching a client to limit his or her caloric intake, in accordance with an embodiment of the invention.

FIG. 3 depicts a user interface on a user's communication device that may be used to present automated coaching suggestions, in accordance with an embodiment of the present invention.

FIG. 4 demonstrates how a user may adjust her daily targets for caloric intake, sodium consumption and/or other substances, according to an embodiment of the invention.

FIG. 5 demonstrates how a user may budget a day's caloric intake among multiple meal events, according to an embodiment of the invention.

FIG. 6 is a flowchart illustrating one method of dynamically escalating attempts to communicate with a user, according to an embodiment of the invention.

### DETAILED DESCRIPTION

The following description is presented to enable any person skilled in the art to make and use the invention, and is provided in the context of a parti- cular application and its requirements. Various modifications to the disclosed embodiments will be readily apparent to those skilled in the art, and the general principles defined herein may be applied to other embodiments and applications without departing from the scope of the present invention. Thus, the present invention is not intended to be limited to the embodiments shown, but is to be accorded the widest scope consistent with the principles and features disclosed herein.

In embodiments of the invention described herein, a system and methods are provided for automated coaching to help monitor and/or restrict a person's behavior to predetermined limits. In particular, automated coaches help the person make decisions regarding whether or not to engage in particular behavior, and may provide options regarding the behavior.

In one embodiment, automated coaching is applied to help a person restrict his or her caloric intake. In this embodiment, a target number of calories per period of time (e.g., one day) is identified, and one or more automated coaches operate to help the person meet that goal. The system tracks the person's caloric intake during the day, may budget remaining calories to one or more meal events, and can respond to queries from the person as to whether he or she could or should consume a particular comestible. For example, if the person wishes to eat a bag of potato chips, the system can advise the person whether that action will cause him or her to exceed the target caloric intake, and/or indicate how he or she will have to reduce consumption at other meals.

For a meal event (e.g., breakfast, lunch, dinner, snack), one or more automated coaches suggest meal options that the person can consume while staying on track regarding the daily caloric limit. Different coaches may be associated with different food vendors (e.g., restaurants, supermarkets), different comestibles, types of food or food ingredients, different geographical areas, etc.

Yet further, different automated coaches or advisors may exhibit different personalities. For example, one coach may be very strict regarding how caloric consumption is budgeted throughout a day and project a stern interface to the person to try to make the person adhere to the budget. This coach may be very persistent about various events, such as ensuring the person consumes a target amount of water, exercises according to plan, and so on. Another coach or advisor may be less assertive and allow the person to vary from a desired plan without comment or complaint.

In other embodiments, automated coaching is provided for other types of behavior, such as restricting one's intake of caffeine, sugar, cholesterol, sodium, carbohydrates, or other substances. In yet other embodiments, coaching may be provided to help a person reduce or restrict his or her consumption of alcohol, cigarettes, illegal drugs, and so on. It may be desirable to restrain consumption of a particular substance because of an allergy, because of problems they cause with one's health (e.g., diabetes, proneness to migraine headaches, ADHD (Attention Deficit Hyperactivity Disorder) or some other syndrome or condition).

In an embodiment of the invention, coaching may also be designed to encourage rather than discourage some behavior. For example, an automated coach may help someone remember to take their medication, drink plenty of water, consume dietary supplements (e.g., antioxidants, vitamins, omega acids), consume certain types of food (e.g., kosher, vegetarian), etc.

The system may interface with health providers or other entities that monitor a person's health issues. For example, the system may interface with Google Health (www.google.com/health), Microsoft Health (www.microsofthealth.com), a doctor's office, a health insurance provider, etc. Through such an interface, the system may provide or receive target data (e.g., maximum number of calories to be consumed daily), measurements (e.g., daily weight, exercises performed), an exercise plan, information regarding preferred foods (e.g., fruits, vegetables) and/or foods or substances to avoid (e.g., sodium, caffeine, animal fat), etc.

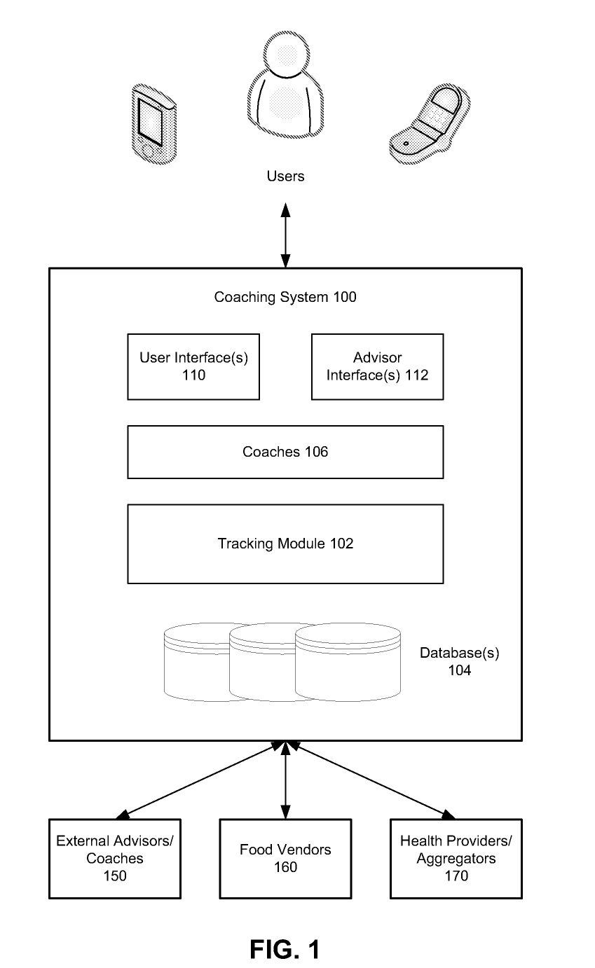

FIG. 1 is a block diagram of a system for automated coaching to promote (or discourage) some behavior, according to one embodiment of the invention. Although implementations of this embodiment may be described as they would be configured to coach someone regarding limiting their caloric intake, one of ordinary skill in the art will appreciate how these implementations may be modified to promote or discourage other behavior, without exceeding the scope of the present invention.

In the embodiment of FIG. 1, coaching system 100 interacts with users via various user interfaces 110 and user devices. For example, a user may interact with the system through a communication device (e.g., wired or wireless telephone, smart phone) or a computing device (e.g., desktop computer, personal digital assistant). User interfaces 110 may include interfaces for wired and/or wired devices using any suitable communication protocol. In particular, user interfaces 110 may include a website, an instant messaging module, an IVR (Interactive Voice Response) module, an electronic mail module, etc.

System 100 includes tracking module 102, which is configured to track users' behavior. In one implementation, tracking module 102 monitors each user's caloric intake per period of time (e.g., one day) as well as calories expended via exercise and/or normal activity. The number of calories expended may be exact or estimated, depending on the level of knowledge of a user's activity (e.g., types of exercises performed, how many, duration) as well as knowledge of the user herself (e.g., age, weight, resting heart-rate, heart-rate during exercise).

The tracking module (or other component of the coaching system) may maintain a profile of each user to help calculate how many calories are burned. Such a profile may reflect how much the user sleeps, how far she walks during a day, typical daily activities, special activities (e.g., a 5K run), and so on. Thus, the tracking module may start with an average or default assumption of the number of calories the user burns during a day, and adjust this based on additional information as it becomes available.

A user profile may also identify the user's food preferences (e.g., condiments she does or does not like, preferred pizza toppings), and may be general (e.g., applicable to all fast food restaurants) or specific to a given vendor.

In one implementation, until a satisfactorily accurate profile of the user's routine during a typical day, week, month or other period of time is generated, the system may gather specific information such as when the user goes to bed, when she wakes up, when she starts her commute to work, when she starts working, when she relaxes, when she eats, etc. As with most operating parameters of coaching system 100, however, the user may bypass this information collection stage if she desires, and can configure her profile at anytime, make adjustments and provide whatever level of information detail she is comfortable with.

In addition to calculating or estimated the expenditure of calories per unit of time, tracking module 102 is also configured to calculate or estimate how many calories a user consumes during the default period of time. As will be seen below, such information may be easily obtained if the user accepts meal options suggested by an automated coach or advisor, as these options will usually identify the number of calories they represent (as well as any other contents of note, such as sodium, caffeine, etc.).

Database(s) 104 store user profiles, details of user behavior (e.g., food consumed, exercise performed), weight measurements, target maximum caloric intake per period of time (and/or other constraints the coaching system will help the user with), and other user information as needed by the coaching system (e.g., user preferences for food, daily routine, meal/snack times). The database(s) may also store information such as locations of food vendors (e.g., restaurants, supermarkets, fast food outlets), nutritional data (e.g., calories and other nutritional information for various foods), etc.

In one implementation, coaching system 100 may interface with an external 3^{rd} party entity to obtain nutritional data as needed. For example, when a particular food or substance is suggested to a user, or the user reports having consumed a particular item, the system may query the external entity to obtain related nutritional information (e.g., calories, sodium, fat, other ingredients).

In one embodiment of the invention, a user may submit a barcode scan of the item and the system examines the scan and queries the external entity (or simply sends the barcode scan to the entity). Some cameras built into mobile telephones have sufficient resolution to take an image of a barcode that can be transmitted to the system and used to retrieve nutritional data. Or, the user may submit a picture of the item and the picture may be analyzed by a human or by image analysis software to identify the item. The user may also report whether she consumed the entire item or only a portion.

Automated coaches 106 provide automated suggestions to users regarding their consumption of food and beverages. A coach may be programmed with default or preferred mealtimes of the user, so that it automatically makes suggestions some time (e.g., 30 minutes, one hour) before the user normally consumes a meal or snack. Or, a coach may act immediately upon being queried by a user.

Regardless of when an automated coach acts, it makes meal suggestions based on a user's target caloric intake for the current time period (e.g., day) and with knowledge of how many calories the user has already consumed, and possibly with knowledge of how many calories have been budgeted for meal events to occur later in the current time period.

In particular, a coach may budget the user's target caloric intake over some number of meal events, based on the user's behavioral profile, which may be learned over time and/or configured directly by the user. For example, a user's profile may specify that during the work week (e.g., Monday through Friday) the user has breakfast at 8:00 am, a snack at 10:00 am, lunch at 12:00 am, a snack at 3:00 pm, dinner at 6:00 pm and a final snack at 8:00 pm. Based on this profile, a coach may automatically present the user with meal/snack options at appropriate times.

Meal options presented by a coach will identify the number of calories each option contains, as well as information regarding any other constraints placed on the user (e.g., consumption of sodium or cholesterol). A range of options may be presented so that the user can easily identify something that closely fits with a number of calories budgeted for the current meal event, or may consume something with more or fewer calories, depending on whether the user is more or less hungry than usual.

Along with the meal options presented by one or more coaches, or as part of the options, a user may be informed of her caloric intake during the current time period, as well as the ramifications of straying from the coaches' suggestions. For example, if the user is tempted by a high calorie meal, the system may alert the user to the fact that succumbing to the temptation will exceed the permitted calories for the period of time, or will require that she will have to abstain from any snacks (or other meal events) through the remainder of the day, etc.

This tempting high calorie meal may be one of the options presented by a coach, or which may be displayed for reference or as a warning. For example, the user may be known to have consumed that high calorie meal before (and therefore may particularly enjoy it). Or, based on the user's location (e.g., by GPS coordinates reported by her telephone), the system may know that the user is currently very near a vendor of that high calorie meal.

As alluded to above, a coach may make suggestions based on the user's current location, as reported by the user or by the user's communication/computing device. Or, the coach or coaches selected to make suggestions may be selected based on the user's location.

In particular, in one embodiment of the invention some or all coaches may be associated or aligned with particular establishments or types of food vendors. Thus, an automated coach associated with McDonalds® restaurants may be configured to suggest meal options offered by that restaurant chain. Another automated coach may be associated with “home cooking” or supermarkets, and may suggest meal options that can be assembled from ingredients purchased and prepared at home. In the latter case, the coach may suggest any number of recipes, which may include simple dishes (i.e., few ingredients and little preparation time) as well as more complex meals.

A meal option may be accompanied by a coupon reducing the cost of that meal. Illustratively, the coupon can be redeemed by ordering the meal option via the user interface or device that presented the option and the coupon, or by showing the coupon to a clerk at the food vendor.

To help an automated coach configure meal options for a user, the system may provide the coach with information regarding the user's likes and dislikes, in addition to the user's caloric budget. For example, if the user (e.g., in her user profile) has expressed preferences related to a food vendor associated with the coach (e.g., favorite sandwiches at Quiznos), or general preferences (e.g., dislikes mayonnaise, likes ketchup), the coach is informed.

A coach may also be activated when a user queries the system regarding a desire to consume something at a time other than during a meal event. The system or coach may respond by indicating whether the item can be consumed without exceeding the daily caloric budget, whether subsequent meal events will have be reduced, etc.

In addition to internal coaches 106, in the embodiment of FIG. 1 one or more external coaches 150 may be configured to provide meal options to users via coaching system 100. As described above, an external coach may be associated with a given food vendor, or may be specialized in a particular area. For example, a specialized external coach 150 may be configured to coach a user who is diabetic or who has a severe allergy to peanuts. This specialized coach may be programmed with detailed knowledge of products that the user can consume without problem.

In an embodiment of the invention, an advisor may differ from a coach in that an advisor may provide information to a coach. Thus, an advisor may be configured to determine how many calories a food item contains, or whether a given outlet of a restaurant offers a particular entree, and so on. External advisors and coaches may interact with coaching system 100 through advisor interface(s) 112.

Food vendors 160 may communicate with the system in order to inform internal coaches 106 of their meal offerings, nutritional data, store locations, and so on. Health providers/aggregators 170 may interact with the system to provide information on users (e.g., doctors' recommendations regarding caloric intake, food allergies, other constraints (e.g., sodium, cholesterol)) and to receive user data such as daily caloric intakes, weight measurements, exercise performed, etc.

Automated coaches, whether internal or external to system 100, may be rated and/or their performance may be monitored and used to promote their services. For example, a coach may be rated by how successful users are at adhering to the coach's specified caloric intake, how much weight the users have lost while following the coach's advice, whether the coach provides variation among meal options, etc.

Although not shown in FIG. 1, coaching system 100 may include various other components normally found in a computer system, such as one or more central processing units, memory, input/output devices (e.g., communication ports and connections, a monitor) and so on. Further, the components and functionality of the coaching system may be divided or replicated between any number of discrete computing devices, which may be collocated or geographically dispersed. Yet further, some or all of the functions of a coaching system may be outsourced to or otherwise provided by a third party, such as a CPU collocation service or a provider of a cloud-type of network service.

Also, in addition to APIs (Automated Programming Interface) exposed to users (e.g., as user interface(s) 110), external advisors/coaches (e.g., as advisor interface(s) 112), coaching system 110 may also offer APIs for interacting with food vendors 160, health providers/aggregators 170 and/or other entities (e.g., governmental entities, advertisers or advertising companies).

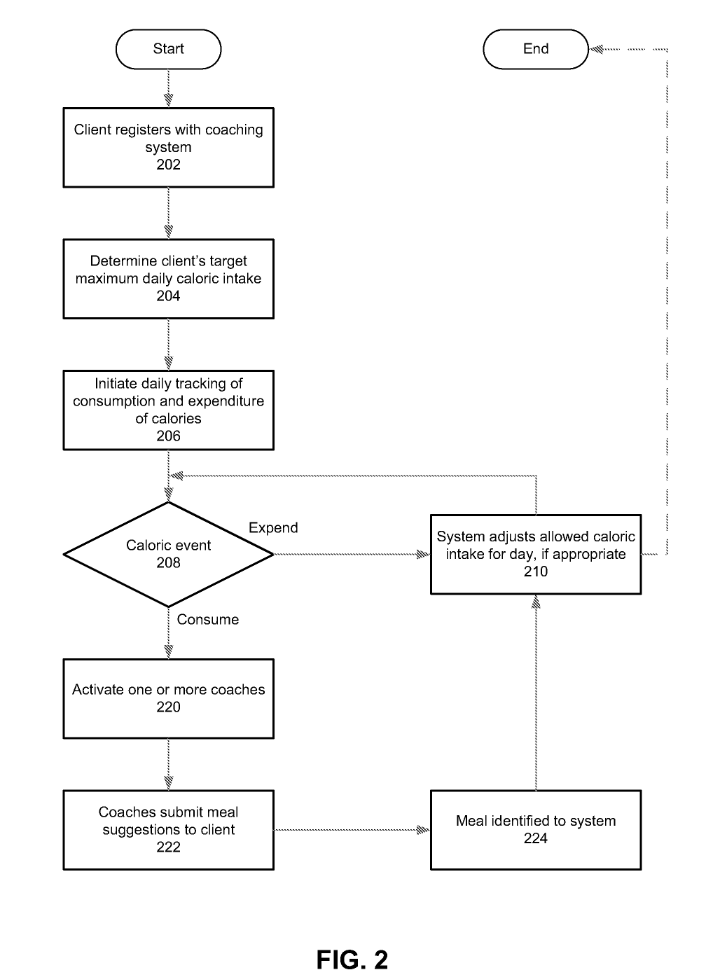

FIG. 2 is a flowchart demonstrating the use of an automated coaching system to help a person restrict their daily caloric intake, according to one embodiment of the invention.

In operation 202, a new client registers with the coaching system. Registration may be performed from the client's computing device at a website associated with the coaching system, although later communications (e.g., meal options, user activities) may be exchanged via other means (e.g., mobile telephone, PDA or personal digital assistant).

As part of the registration process the user provides various information to be saved in his profile, such as name, age, sex, contact information, address, food preferences, etc. He may also identify one or more automated coaches, or desired attributes of coaches to be assigned to him. A coach may be selected based on personality, a company or brand associated with the coach, a method of communication used by the coach, or some other factor.

A coach's personality may indicate, for example, how persistent the coach is in contacting the client to ensure he takes some action (e.g., drinks a glass of water, exercises), how lenient the coach is, etc. Illustratively, a “lenient” coach may not protest when the client consumes additional calories or asks for additional meal options that involve more calories. A “strict” coach may refuse to vary from a particular diet, may only provide meal options that ensure the client will not exceed his allowed number of calories, etc.

A coach's personality may also, or instead, encompass other traits or characteristics, such as a language in which the coach can communicate, method(s) of communication the coach uses (e.g., electronic mail, text messaging, telephone), and so on.

In operation 204, the constraint(s) with which the coaching system will help the client are identified. In the illustrated embodiment of the invention, the primary constraint is a maximum number of calories to be consumed per day (or other time period). As described previously, in other embodiments of the invention the client's constraint(s) may include particular food items or ingredients (e.g., sodium, cholesterol, saturated fat, peanuts), habit-forming substances (e.g., cigarettes, caffeine, alcohol) or, alternatively, something the client should consume more of (e.g., water, vitamins).

The client's constraint(s) may be learned during his registration process or afterward, and may be received directly from the client or from a third party (e.g., the client's doctor or other caregiver, another medical-related website). A constraint may be allowed to be viewed and/or modified by specified parties (e.g., the client's doctor).

As another alternative, the user may request the coaching system to determine the magnitude of the constraint. For example, the client may simply desire to lose weight, and may ask the system to determine how to accomplish this goal. The system may then elicit information such as current weight, height, age, sex, medical condition, medical history, target weight, a period of time over which the client wishes to lose the weight (e.g., six months, one year), and so on. The system may then compute a recommended maximum daily caloric intake (e.g., 1500 calories).

In different embodiments of the invention, the automated coaching may begin immediately or at some time after the client registers and his constraints are determined. In the embodiment depicted in FIG. 2, coaching begins the day after he registers.

In operation 206, at the start of the day (or ahead of time, in anticipation of the new day), the system notes the number of calories the client may consume during the day. The client's behavior (e.g., eating, exercise) during the day will be tracked from this point. Illustratively, the system may be more permissive on some days (e.g., holidays, weekends) and allow the consumption of additional calories, and offset that leniency with reduced intake on other days (e.g., workdays, days the client does not exercise).

In the method depicted in FIG. 2, the client's day starts when he awakes or at some predetermined time (e.g., 7:00 am). Illustratively, the start of the client's day may be programmed as part of his profile, may be set by the user the night before or may be learned from his behavior.

For example, if the user's communication device (e.g., a smart phone) with which he interacts with the coaching system also includes an alarm, the time at which he is woken by the alarm may be used as the start of the day. Or, when he answers his telephone for the first time during the day (or makes a first call), that time may be used as the start of the day. In one implementation, an automated coach may wake the client by telephone call at a predetermined time.

In an alternative embodiment of the invention, the client or some other entity (e.g., health provider, diet planner) may identify a schedule of daily meal events for the client. A meal may include a conventional event such as breakfast, lunch or dinner, and may also include snacks.

However, in the illustrated embodiment of the invention the system learns of meal events from the client's behavior and adapts to the client's schedule over time. For example, if the system observes that several work days in a row the client eats at approximately 12:30 pm (at which time he asks the system for meal suggestions), the system will assume that this is a normal meal time and (as described below) start to make suggestions around that time. Regardless of whether meal events are preplanned or learned over time, a client may always initiate a meal event to obtain suggestions and report his actual behavior.

In one embodiment of the invention, a daily meal plan (including snacks) may be configured for the client in advance. This plan may be predetermined by the system, a particular coach, the client's health care provider, the client himself, or some other entity.

Illustratively, a meal plan may budget various amounts of calories to preplanned meal events (e.g., breakfast, lunch, dinner, snacks), and may be defined strictly (e.g., with minimal allowance for alteration at the time of an event) or loosely (e.g., with wide latitude given for alteration).

A meal plan may therefore provide a starting point for the client's daily consumption, and be altered as the day progresses. For example, the client may skip breakfast or a snack, in which case the calories allotted to those events can be manually or automatically distributed among the remaining meal events (or may be “hidden” to help the client consume even less than the allowed number of calories).

Also, at the start of the day the automated coaching system may send (e.g., electronic mail, text message) pertinent reminders. For example, the client may be reminded that he is supposed to exercise today, that a special meal event is scheduled for today (e.g., lunch with a business associate), that he consumed too many calories in one or more previous days, etc.

In operation 208, the client alerts the system of an event occurring now. Other than meal events, a primary type of event the system tracks is exercise. In other implementations other types of events may be defined and tracked. If the event involves the consumption of calories (e.g., a meal), the method advances to operation 220; if the event involves the expenditure of calories (e.g., exercise), the method continues with operation 210.

In operation 210, the system learns the details of the exercise and may adjust the number of calories the client is permitted to consume the remainder of the day. For example, if the client burned 200 calories, his daily limit of calories he may consume may be increased by 200. However, if the exercise was preplanned, the target caloric intake for the day may already reflect the expected exercise, in which case no adjustment is made (unless the client does not perform the exercise).

The exercise may involve a substantial work-out (e.g., jogging, weight-lifting) or may simply involve a walk or other event. The client may describe the activity with any level of detail (e.g., distance covered, time involved) or may enter a number of calories expended, if known (e.g., as reported by a treadmill or other machine). If the client does not estimate the number of calories, the system does so based on the information provided by the client.

The client may have provided various exercise information during the registration procedure or while updating his profile. For example, he may describe various exercise plans he uses to describe different work-outs he performs on different days. When reporting an exercise event, he may then report which plan he followed.

In one embodiment of the invention, a coach may assemble one or more exercise plans for a client. Such plans may consider the client's limitations (e.g., torn ligaments in knee, bad back) as well as the client's preferred exercise (e.g., swimming, playing basketball, jogging). The more information the system receives or generates regarding a client's exercise, the more accurate it can be in tracking the client's daily behavior.

After operation 210, the system returns to operation 208 for the next event or, if the day has ended, the method ends.

In operation 220, the system activates one or more coaches, including any applicable coaches the client had elected. Different coaches may be activated for different times of day, different geographic locations, different amounts of calories the client is permitted to consume, and/or based on other factors.

In one implementation, the client's location at the time of the meal event (e.g., as reported by the client or the client's GPS-equipped mobile telephone) is identified. Any elected coaches (or, alternatively, all coaches not expressly rejected by the client) that are associated with food vendors within some distance of that location (e.g., 1 mile, 5 minutes walking distance) may then be activated. Or, the client may specify exactly which coaches he wishes to receive recommendations from. Yet further, the system may present special coaches, or special options suggested by a coach (e.g., based on a discounted price, a new entree, a newly opened restaurant).

In operation 220, the activated coaches present any number of meal suggestions or options to the client (e.g., via the coaching system). A coach may be provided with relevant information if it (e.g., an external coach) does not already have it. Such information may include a maximum number of calories (or a range of calories) the client may consume at this meal, dietary constraints (e.g., must avoid sodium, needs iron), food preferences (e.g., does not like broccoli, likes pasta), preferred condiments (e.g., ketchup, onions), food allergies and so on.

In one embodiment of the invention, some or all meal suggestions are accompanied by relevant details (e.g., calories, sodium, cost). The details may be displayed with the corresponding option or, to conserve space, may be accessed via a link displayed with the option.

In one implementation, a meal option may be accompanied by a link to “buy now” (or similar language) that allows the client to place an order for that meal or snack. The order may be relayed to the specified vendor through the automated coach that presented the option, or via the coaching system.

In operation 222, the client reports what he consumed (or is going to consume) for this meal event. Illustratively, a meal option may include a link or control to easily report to the system that the client has chosen that option. For example, if a “buy now” link is not activated, the client may activate an “I ate this” (or similar) link to report his action.

If the client does not consume one of the suggested meals/snacks, in which case the system does not simply receive the corresponding calorie data from the associated coach, the client describes the contents of his meal separately (or reports that he did not eat anything). Illustratively, the client may select the meal components from a list (e.g., a list of items he has eaten previously, a menu from a nearby food provider) or enter them directly via text, as an image of the meal, by scanning barcodes of the components, submitting a voice message describing the components, or in some other manner.

After operation 224, the system continues at operation 210, wherein the client's allowed caloric intake for the remainder of the day is updated based on what he consumed for the meal. This may cause the number of calories allocated to a later meal event to be increased or decreased. For example, if the meal was an afternoon snack and he consumed more than was budgeted for, the number of calories allocated to dinner may be decreased.

As seen in FIG. 2, operation of the automated coaching system continues throughout the day to track the client's caloric consumption and expenditure. At any time, daily (or other) statistics can be requested by the client, he may be warned that he is approaching the maximum number of calories, he may request some number of calories be reserved for later in the day (e.g., for happy hour, for a special dinner), and so on.

Coaches will be as intrusive or insistent as permitted or specified by the client when he selected the coaches, and may be cancelled or elected at any time. Similarly, the client can tell the system to remain inactive for some period of time (e.g., one day, one week), perhaps because the client is sick, on vacation, etc. While inactive, the system will not issue meal suggestions (unless the client specifically requests them), but may continue to track the client's consumption—to the extent the client reports this information.

The system may also look ahead any amount of time. For example, if the client specifies that a special event in the future will involve an abnormal consumption (e.g., a barbeque, a wedding reception), the system can be requested to plan a pattern of reduced caloric consumption before and/or after that event.

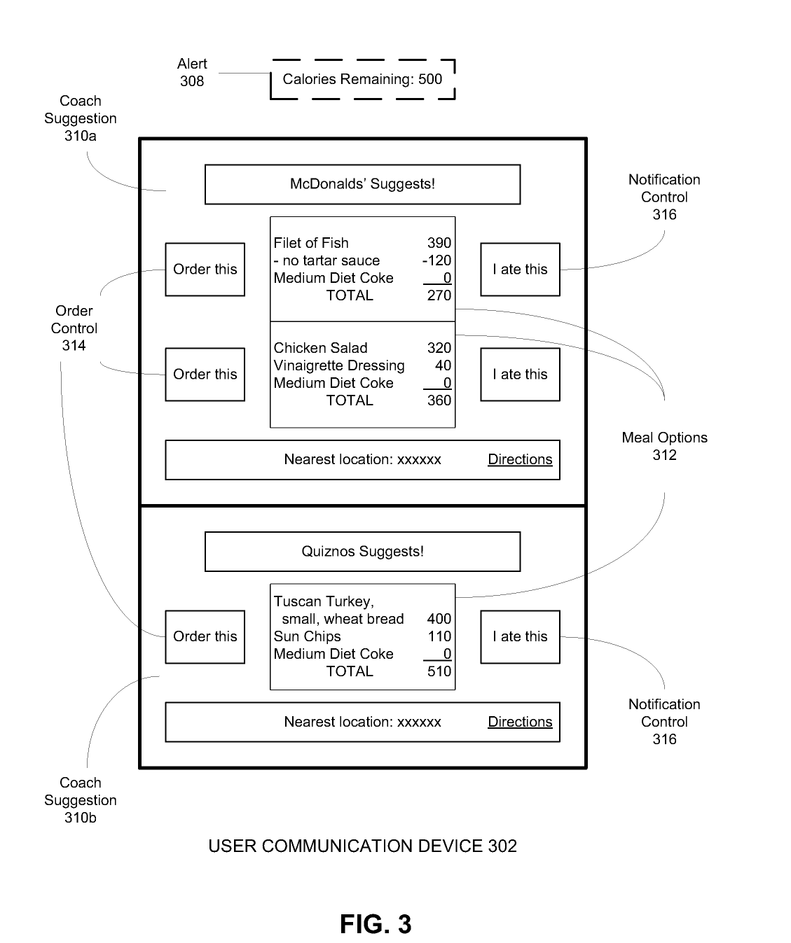

FIG. 3 illustrates how automated coaches' suggestions may be presented to a user in one embodiment of the invention. In this embodiment, the suggestions are presented on the user's mobile telephone, which has a relatively large display component. In other embodiments of the invention, a coach's suggestions may be presented in less space and/or on different types of communication or computing devices.

In the embodiment of FIG. 3, user communication device 302 (e.g., an iPhone®) displays the indicated information automatically when a meal event is scheduled or when the user requests suggestions. Alert 308, which is optional, informs the user how many calories remain in the current time period (e.g., day), so the user can see the impact of the various meal options on the day's caloric budget.

Any number of coach suggestions 310 (e.g., suggestions 310a, 310b) may be displayed and, if necessary, the user can scroll through the suggestions if there are too many to fit on the device's display component at one time. As reflected in FIG. 3, in this embodiment of the invention the coaches that submitted suggestions 310a and 310b are aligned with particular food vendors. In other embodiments of the invention a coach may suggest meal options comprising products of multiple vendors.

Within a given coach suggestion 310, any number of meal options 312 may be presented. Illustratively, each option identifies the number of calories that would be eaten if that option is consumed.

Meal options may be accompanied by relevant controls, such as order control 314 for submitting an order for the corresponding meal option, and notification control 316 for notifying the automated coaching system that the user has consumed this meal option. Other data may also accompany a meal option, such as how many calories will remain in the day's budget if the option is adopted, how the option satisfies other targets (e.g., vitamin C, carbohydrates, iron).

Various other information may also be presented with a coach's suggestion, such as a location of one or more vendors from which the suggested meal options may be obtained, directions to a vendor, etc. The user interface through which coach suggestions 310 are displayed may also offer a link to a vendor's ordering system, so that the user can directly access the vendor's menu, configure a custom meal, alter a suggested meal, place an order, make an electronic payment and so on.

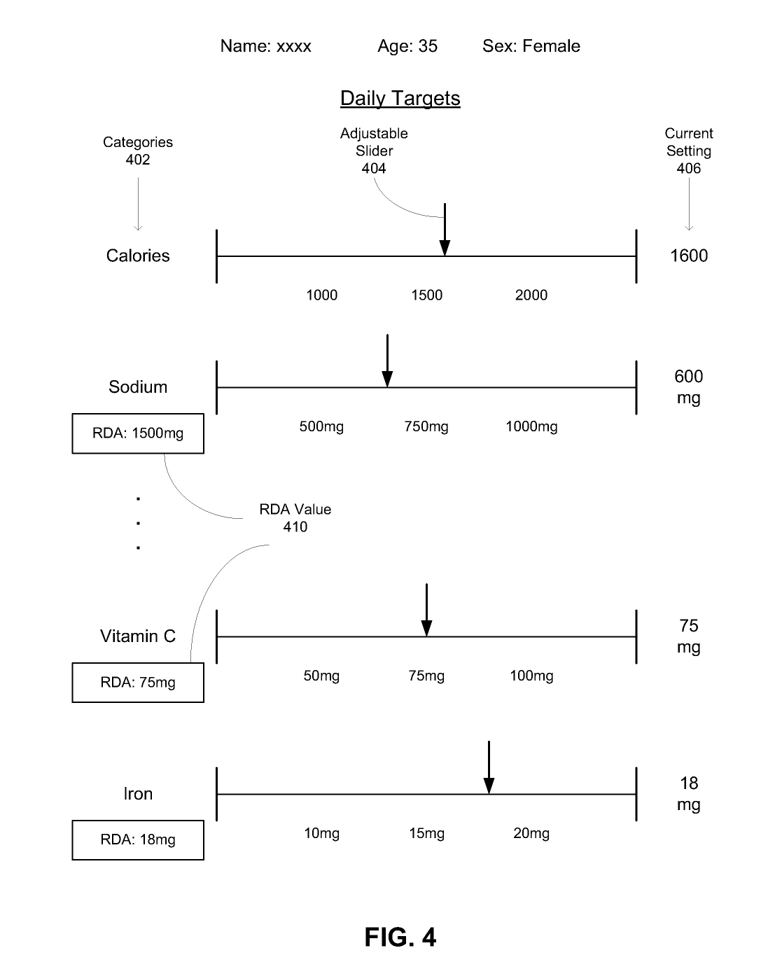

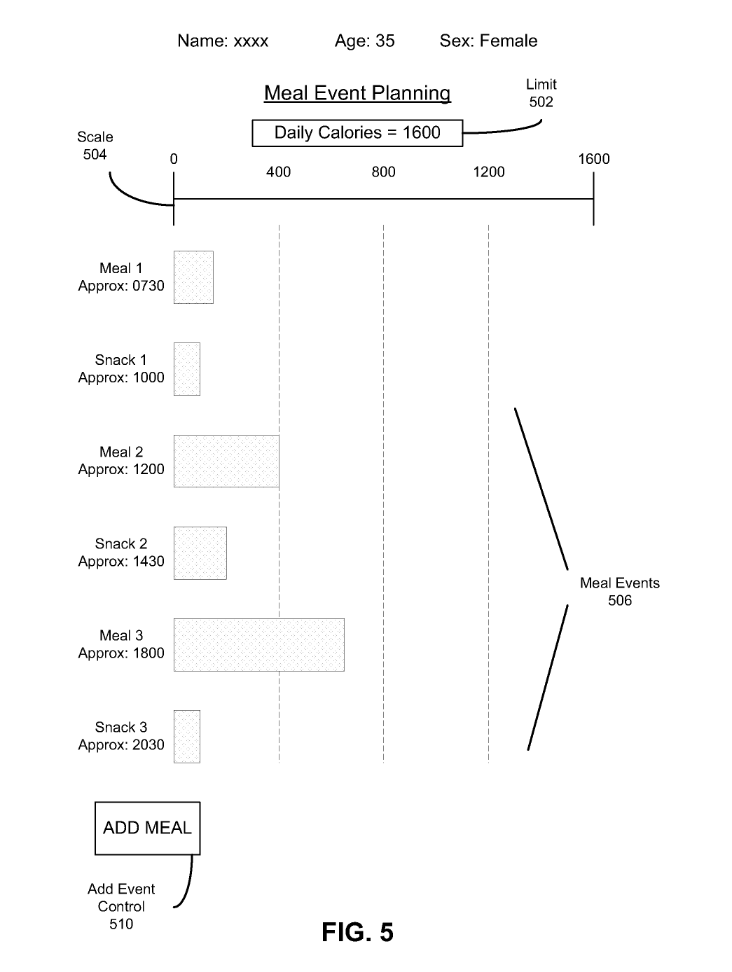

As described above, a user profile within the automated coaching system may be used to store user data. FIGS. 4-5 diagram how a user may configure her profile to affect the behavior of the coaching system.

FIG. 4 demonstrates how the user may adjust her daily targets for caloric intake, sodium consumption and/or other substances, according to an embodiment of the invention. FIG. 5 demonstrates how the user may budget a day's caloric intake among multiple meal events, according to an embodiment of the invention.

In FIG. 4, various categories of dietary allowances, constraints and/or other substances are listed. The user can use sliders to adjust her target allowances, and the automated coaches will attempt to meet those targets. The categories may be prioritized (e.g., calories may be the top priority because that category is listed first), which the user can adjust as desired (e.g., by changing the order of categories, by using index numbers). The current target value is also identified, which changes as the user manipulates the sliders. Alternately, she may enter a value directly in the settings field. Additional information may be presented to help a user make adjustments, such as the Recommended Daily Allowance values for users in her demographic group (e.g., age and sex).

Although only a few categories are illustrated in FIG. 4, any number may be tracked for a user, and users may select any or all of them to monitor. In addition to the various vitamins, the system may monitor minerals, carbohydrates, fat, protein, sugar, sodium, antioxidants, caffeine and virtually any other type of substance listed in a food item's nutritional data.

Although FIG. 4 demonstrates one interface for capturing a user's target intakes, any other method or interface may be employed without exceeding the scope of the invention.

In FIG. 5, a user is able to allocate her maximum daily caloric intake among any number of meal events, which include traditional events such as breakfast, lunch and dinner, as well as snacks. In this example user interface, the user's daily limit 502 is displayed, along with any number of meal events 506, plus a scale 504 for easily interpreting the bar graphs. Add event control 510 may be activated to add a meal event, and an existing event may be deleted or modified by selecting it.

As the user adjusts an event's bar graph, which reflects a target number of calories for meal option suggested for that event, other events' graphs may alter. In particular, when the user has completely allocated the maximum daily calories, if she increases one event's budget (i.e., by clicking on and lengthening its bar graph), some or all other events' graphs will shrink.

FIG. 5 illustrates just one possible implementation of a user interface for budgeting a user's daily caloric intake among multiple meal events. Other interfaces may be employed within the scope of the invention. For example, different budgets may be configured, and the user may choose among them to reflect her day's activities, the type of day (e.g., weekend, weekday, holiday, vacation), her mood, etc. Yet further, and as described above, in one embodiment of the invention the automated coaching system learns the user's behavior over time and may automatically configure one or more calorie budgets.

In some embodiments of the invention, a method of dynamically escalating contact with a user may be exercised to ensure the user takes some action (e.g., ingests a vitamin, exercises), reports some information (e.g., a weight measurement, what was consumed for a meal), or for some other reason.

More particularly, in these embodiments the automated coaching system (or a particular automated coach or advisor) or some other entity initiates a notification or elicits some action or information at a relatively low level of priority. This initial contact may be via electronic mail, instant message, displaying an icon or control on the user's communication device, etc.

If the user does not respond to the initial communication, a more urgent contact is attempted, such as a text message, a beep or other tone on the communication device, etc. This escalation may increase through any number of levels until a most urgent type of communication is attempted (e.g., a telephone call).

The type of communication attempted and the rate of escalation may depend on the reason for the contact. For example, if the automated coaching system is simply awaiting a daily weight measurement or is reminding the user to consume a glass of water, then communication attempts may be abandoned after just one contact. However, if the contact is of a more urgent nature (e.g., to remind a diabetic user to test his glucose level), then the full range of contact attempts may be made, even to the point of contacting emergency medical services for extreme situations.

Dynamic escalation of contact with a user may also be employed outside the realm of automated coaching. For example, it may be used to wake a person, remind a user of an appointment or other engagement, or for other purposes. Contacts initiated during dynamic escalation may employ various devices associated with the target user (e.g., electronic mail or instant messages to a computing device, audible alerts to a pager or other communication device, telephone calls).

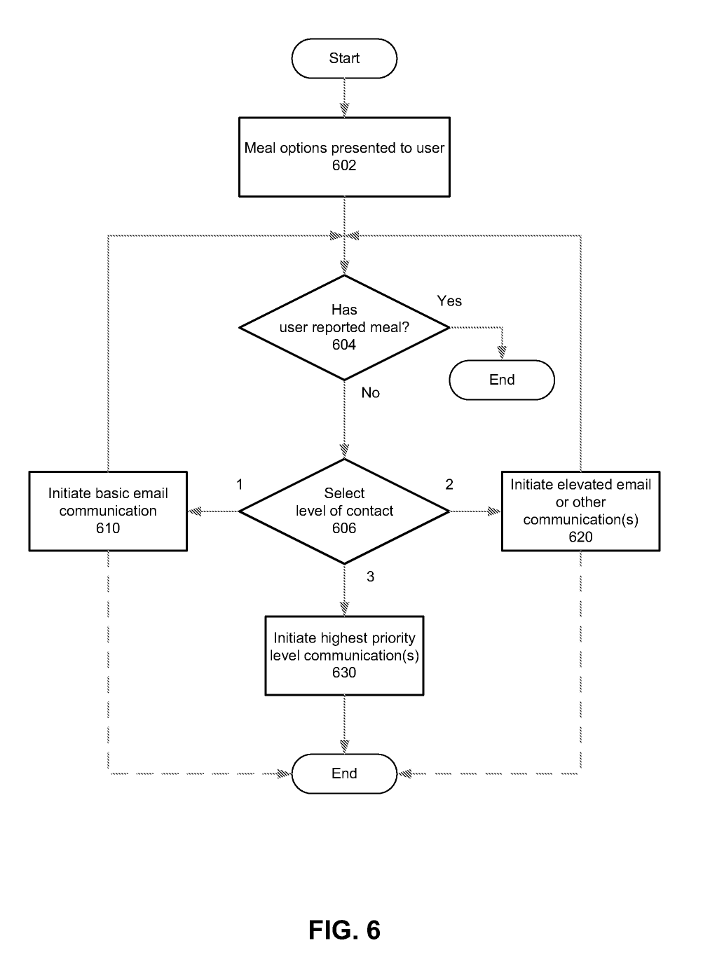

FIG. 6 is a flowchart illustrating a method of dynamically escalating communication attempts with a user, according to one embodiment of the invention. In this embodiment, the contact relates to automated coaching a user to control her caloric intake and is done for the purpose of obtaining information from the user. In other embodiments, similar methods may be implemented for virtually any purpose—one-way (i.e., to notify or alert the user) or two-way (i.e., to obtain information from the user—without exceeding the scope of the current invention.

In operation 602, an automated coach or automated coaching system presents some number of meal options to the user in association with a meal event (e.g., lunch, snack). As described previously, the meal options may be accompanied by caloric and/or nutritional information relating to the options, a control for ordering an option, etc.

In operation 604, the coach or system determines whether the user has reported what, if anything, she has consumed for this meal event. The user interface that presented the meal options to the user in operation 602 may allow the user to report which meal option she consumed (if any), to report consumption of a modified version of one of the options (and describe the modification), to report that she skipped this meal event (i.e., did not consume anything), or to report consumption of something not suggested.

If the user did not report what she consumed for the meal, in operation 606 the system selects an appropriate level of notification or request to dispatch to the user. In the embodiment of the invention depicted in FIG. 6, three levels of contact are contemplated; in other embodiments any number may be attempted. As described below, in one embodiment the system may make multiple contact attempts, and escalate the contact after one or more unsuccessful attempts at the current level.

The type of contact initiated depends on how many, if any, previous contacts were attempted for the same purpose. If this is the first attempt, the method continues at operation 610; for the second attempt the method advances to operation 620; for the third attempt the method advances to operation 630.

In operation 610, a first reminder of the need to report her consumption is dispatched to her telephone or other communication device. Illustratively, this initial level of communication may comprise a simple electronic mail message transmitted to an address provided by the user, in which the user is asked to report her meal. If there is no response from the user within some period of time (e.g., 30 minutes), the method returns to operation 606.

In operation 620, an urgent or prioritized electronic mail message is transmitted to one or more addresses (e.g., all addresses known to be associated with the user). The system may also, or instead, send a communication having a higher profile (e.g., an instant message, a text message on a cellular telephone, an alert on a smart phone). If the user still does not respond within a given period of time (e.g., 15 minutes), the method returns to operation 606.

In operation 630, the system initiates a top-level method of communication, which may illustratively involve a text message or a telephone call from an IVR (Interactive Voice Response) system or a human operator. If the user still does not respond, the system may return to operation 606 and continue attempting to contact the user, or may abandon the attempt.

In an embodiment of the invention, a user may be able to disable dynamic escalations or, alternatively, all notifications (permanently, for one day, or for some other time period). For example, she may be in an extended meeting, may be taking a day off from her diet, might be playing with her children, etc.

In some embodiments of the invention, a user's computing or communication device may be specifically configured to operate effectively with an automated coaching system. This may require one or more applications, applets or add-ons to be installed on the device. If the user's device is equipped with a browser, the device may be directed to various web pages or sites associated with the system in order to allow the user to provide information (e.g., configure her profile, report a weight measurement, specify preferences), obtain nutritional data and/or guidance, etc.

In one alternative embodiment of the invention, a coaching system provides meal suggestions to a user based simply on one or more parameters identified by the user, without necessarily tracking the user's daily caloric (or other) consumption. The user may therefore remain anonymous, or may avoid having to provide information that she would rather not divulge.

In this alternative embodiment, the user submits her meal constraints (e.g., 400 calories, 400 calories and low sodium, 400 calories and low sodium and vegetarian) and/or keywords of desired meal characteristics and/or ingredients (e.g., tuna, pizza, Chinese), and the system uses the parameters and the user's location to make suggestions (e.g., by activating one or more suitable coaches). Location information may be provided manually by the user (e.g., by entering an address or zip code), automatically from a GPS device associated with the user (e.g., in her telephone) or in some other manner. Illustratively, the meal suggestions may be presented to the user in textual format.

The environment in which a present embodiment of the invention is executed may incorporate a general-purpose computer or a special-purpose device such as a hand-held computer. Details of such devices (e.g., processor, memory, data storage, display) may be omitted for the sake of clarity.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described below can be included in hardware modules. For example, the hardware modules may include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. The scope of the invention is defined by the appended claims, not the preceding disclosure.

What is claimed is:

1. An automated method of coaching a person to constrain their caloric intake, the method comprising:
identifying a target caloric intake per period of time for the person; and
in association with a meal event, transmitting at least one meal option to the person's communication device, wherein a total number of calories of each said option can be consumed by the person without exceeding the target caloric intake for the current period of time.

2. The method of claim 1, further comprising:
associating one or more automated coaches with the person;
wherein said meal options are identified by the coaches.

3. The method of claim 2, wherein each automated coach is associated with a different vendor of food.

4. The method of claim 2, wherein a first automated coach is selected for the person based on a personality of the coach.

5. The method of claim 4, wherein the personality of the coach indicates a level of persistence with which the coach contacts the person to enforce the target caloric intake.

6. The method of claim 1, further comprising:
for each period of time, budgeting portions of the target caloric intake to each of multiple meal events during the period of time.

7. The method of claim 6, further comprising:
for a given meal event, automatically adjusting the budgeted caloric intakes for subsequent meal events in the period of time based on an actual caloric intake during the given meal event.

8. The method of claim 1, further comprising:
for each of multiple meal events during the period of time, receiving from the person indications of what the person consumed for the meal event; and
tracking the person's caloric intake during the period of time.

9. The method of claim 1, further comprising:
identifying a current location of the person; and
including in the at least one meal option a first meal option available at a vendor near the person's current location.

10. The method of claim 1, further comprising:
receiving from the person a query regarding a comestible;
determining whether the person can consume the comestible without exceeding the target caloric intake; and
transmitting to the person an indication as to whether the person may consume the comestible.

11. The method of claim 1, further comprising:
receiving from the person an artifact of a comestible consumed by the person; and
retrieving nutritional information pertaining to the comestible.

12. The method of claim 11, wherein the artifact comprises a picture of the comestible.

13. The method of claim 11, wherein the artifact comprises a barcode scan of the comestible.

14. A computer-readable medium storing instructions that, when executed by a computer, cause the computer to perform a method comprising:
identifying a target caloric intake per period of time for the person; and
in association with a meal event, transmitting at least one meal option to the person's communication device, wherein a total number of calories of each said option can be consumed by the person without exceeding the target caloric intake for the current period of time.

15. An automated method of helping a person constrain their intake of a substance, the method comprising:
identifying the substance;
identifying a target daily limit of consumption of the substance by the person; and
during each day:
receiving one or more indications of a quantity of the substance consumed by the person;
automatically tracking the quantity of the substance consumed by the person during the day; and
electronically transmitting to the person an indication as to whether the person may consume more of the substance.

16. The method of claim 15, wherein the substance is food.

17. The method of claim 15, wherein the substance is alcohol.

18. The method of claim 15, wherein the substance is tobacco.

19. The method of claim 15, wherein the substance is an illegal drug.

20. The method of claim 15, wherein the substance is an ingredient of some foods.

21. An automated method of suggesting a set of meal options for a single meal to a user based on one or more constraints, the method comprising:
receiving the one or more constraints in an electronic communication originated by the user;
receiving electronic data configured to identify a location of the user;
selecting the set of meal options, wherein each meal option satisfies the one or more constraints and is available near the location of the user; and
communicating to the user the set of meal options.

22. The method of claim 21, wherein the set of meal options is presented to the user textually, without pictures of the meal options.

23. The method of claim 21, wherein the electronic communication comprises the electronic data.

24. The method of claim 21, wherein the electronic data is transmitted by a communication device from which the electronic communication is sent.

25. The method of claim 21, wherein the one or more constraints include a first constraint identifying a maximum number of calories.

26. The method of claim 21, wherein the one or more constraints include a first constraint identifying a dietary restriction of the user.

27. The method of claim 21, wherein the one or more constraints include a first constraint identifying an ingredient desired by the user.

28. The method of claim 21, wherein the electronic data comprises Global Positioning Satellite coordinates.

29. The method of claim 21, wherein the electronic data comprises an address.

30. An apparatus for coaching a person to constrain their intake of a substance, the apparatus comprising:
a communication module configured to communicate with one or more communication devices operated by the person;
a first data storage configured to track the person's consumption of the substance;
a processor configured to determine whether the person may consume more of the substance without exceeding a target limit of the substance in a given time period; and
if the person may consume more of the substance without exceeding the target limit, an electronic coach configured to suggest one or more options for consuming more of the substance.

31. The apparatus of claim 30, further comprising:
a second data storage configured to store consumption options to offer the person when the person indicates a desire to consume the substance.
